(19) United States
(12) Patent Application Publication
(10) Pub. No.: US 2019/0217661 A1
(43) Pub. Date: Jul. 18, 2019

(54) Vehicle Wheel System And Method Of Manufacturing A Wheel And Tire Assembly

(71) Applicant: Andre Luiz Coutinho Alves da Silva, Rio de Janeiro (BR)

(72) Inventor: Andre Luiz Coutinho Alves da Silva, Rio de Janeiro (BR)

(21) Appl. No.: 16/230,625

(22) Filed: Dec. 21, 2018

(30) Foreign Application Priority Data
Jan. 16, 2018 (BR) 1020180008820
Dec. 6, 2018 (BR) 1020180752545

(51) Int. Cl. B60B 23/10; B60B 21/06; B60B 11/06; A61G 5/02

(52) U.S. Cl. CPC B60B 23/10; A61G 5/02; B60B 11/06; B60B 21/062

(57) ABSTRACT

A tire and wheel system having a core and an over-injected tire in the core, and a method of manufacturing a wheel and tire assembly. The tire and core assembly is coupled to the wheel by the engagement of an indentation of the core in a recess of the wheel. When used in a wheelchair, a plastic or metal thrust ring is coupled on the wheel by pins and screws in order to make it possible to transfer movement to the wheel.

### TECHNICAL FIELD

The present invention refers to a wheel system for a vehicle comprising a wheel structure, a core and a tire, and it may be used in vehicles, preferably light vehicles, for example, wheelchairs, bicycles, velocipedes and others.

### DESCRIPTION OF THE STATE OF THE ART

Currently, a wheel and tire assembly for a two-wheeled vehicle, or for a wheelchair, in most cases, comprises a metal or plastic wheel, and a tire with or without a tube. For example, in the case of a wheelchair, the rear wheels are usually made of plastic resin and generally have two types of tires.

A solid tire, manufactured with a rubber-based blend and various fillers. Wherein such tire is placed by means of a mechanical equipment that stretches it to fit it in the gutter of the wheel.

There is also another type of tire found on bicycles, which is the inflatable tire with tube. This tire is assembled using specific tools.

Inflatable tires can be punctured and uncalibrated, creating an inconvenience for a user with reduced mobility.

In turn, the solid tires, due to the high presence of fillers, which reduce their cost of production, have pronounced wear and mark the floor with carbon blacks (black filler used in high percentage to leave it in the color black and reduce price).

It is noted that the use of fillers is necessary and important for obtaining the desired properties. A filler, according to ISO 1382:1996, is an “ingredient of solid composition usually added in relative large amounts to the rubber or latex compositions for technical or economic reasons”. The fillers are intended to improve mechanical properties (reinforcing fillers) and lower the price of the compound (filling or dilution fillers).

The choice of a filler and its proportion in the compound depends mainly on the properties required to the vulcanizate. The fillers are added to provide hardness, toughness, stiffness, abrasion resistance, electrical conductivity, dynamic properties, lower price, etc. The fillers influence the viscosity of the rubber compound and the contraction. In general, the higher the filler volume, the greater the compound viscosity and production problems. The various types of fillers may be combined in the same rubber compound, depending on the desired properties and the desired price.

The maximum amount of a filler, which may be incorporated into a rubber compound, depends on the elastomer, the type and amount of plasticizer used and the nature and ability to provide reinforcement of the filler.

Carbon black, commonly known as lampblack, is a black reinforcing filler, and together with silica is one of the most used fillers.

In the present specification, it will be discussed, by way of illustration, a wheel assembly to be applied preferably in wheelchairs, however nothing prevents the assembly from being applied to any light vehicle using wheels. For example, in wheels for adult wheelchair, which are generally of 24″, and in bicycle wheels, which range from 12″ to 26″ (12, 14, 16, 18, 20, 22, 24 and 26″). In the latter case, the system of the invention would have to be shaped for each different diameter, but the principle of core would be the same.

It is important to notice that, in addition to the two types previously described, there is still a third type of wheel system, comprising a tire made of a bi-component foam expanded with internal cord, acting as a stretching reducer, which is intended to simulate the Inflatable tire. Such foam makes it solid, makes it comfortable and prevents it from puncturing; however, it has drawbacks as it is used by few due to the high commercial value. In addition, because depigmentation occurs in a short time, it tends to become yellowish. Another drawback is that it is only found in the foreign market and it is difficult to import.

In short, currently, there are three types of tires for use in wheelchairs, the latter being practically unfeasible on account of cost. Thus, the three types are as follows: Solid rubber (it is cheap, it does not puncture, but it is hard and uncomfortable), tire with bicycle type tube (it has a reasonable price, but it punctures and is uncalibrated) and the tire made by an expanded foam, which makes it solid and simulates the inflatable tire, (it does not puncture and it is comfortable, but it is very expensive, difficult to import and it loses color).

Japanese Patent Document JP2009056043, published on Mar. 19, 2009, deals with the provision of a thrust ring connection structure, which connects said thrust ring to a wheel of a wheelchair. The idea of the invention described therein is that, in the connection structure of the thrust ring, screw a support with a first fastening screw (a male screw) into the inner surface of an aluminum ring before the tire is assembled. At the time a protruding part of the support is out of the aluminum ring, the tire is secured to the aluminum ring with the support.

A pressure flange is applied to the thrust ring, contacting the faces of the protruding parts of a plurality of supports, and it is connected to the thrust ring, which contacts the faces with screws. Thus, the thrust ring is physically attached to the wheel.

The invention described in this document is not intended to facilitate the assembly of the tire on the wheel, but rather to facilitate that the thrust ring be assembled and disassembled without the need for full disassembly of the tire and wheel assembly. That is, this is made by the connection structures arranged in a removable manner. Thus, there is no facility for tire replacement on wheels, the same being made in the traditional manner.

Another patent document, U.S. Pat. No. 4,371,213, which was published on Feb. 1, 1983, refers to a dual wheel having a plurality of inner and outer spoke members and fastening assemblies. Each inner spoke member has a ring portion, which comprises a radially inclined surface, and an adjacent radially directed surface oriented in a plane substantially perpendicular to the rotational axis of the wheel. Each outer spoke member has a ring portion, which comprises spaced-apart axially projecting wing portions, providing outwardly facing for pairs of surfaces axially inner and axially outer oriented from axially bent surfaces. Furthermore, a surface is radially directed so as to extend inwardly between the axially inner pair of axially oriented surfaces which are substantially perpendicular to the rotational axis of the wheel, and provide a mounting location for an axially projecting member of a fastening assembly.

One object of the invention described in said prior art document is to enable large diameter tires to be mounted on small diameter rings by means of the fastening assemblies described therein. One of the drawbacks is the difficulty to perform the fastening of the spokes and the rings to the assembly of the tires. In fact, the fastening system requires the tightening of screws, and makes the assembly of the tire and wheel assembly take a long time to be accomplished.

The present invention aims to solve these and other drawbacks, as will be better described below.

### OBJECTS OF THE INVENTION

It is an object of the invention to cause the replacement, when necessary, of the tire assembly to be made rapidly.

It is an object of the invention to reduce the acquisition costs of the tire assembly.

It is another object of the invention to prevent the surfaces of the floors from being marked by the use of the tires.

It is another object of the invention to provide a wheel assembly having a running with great softness.

It is another object of the invention to increase the durability of the tires.

It is another object of the invention to prevent the tire from escaping from the ring gutter.

It is another object of the invention to provide options of permanent colors, which will not yellow with the use.

It is another object of the invention to provide a tire system which, being solid, with rigid core, does not puncture or becomes uncalibrated and simulates the softness of the pneumatic tire.

### SUMMARY OF THE INVENTION

The present invention uses materials of thermoplastic resin, or any plastic product, from rigid to flexible, from plastic grain produced in petrochemicals or recyclers.

The tire used in the present invention is made of flexible plastic, but has a quite different construction from those mentioned in the state of the art, since to prevent it from escaping from the wheel gutter, during its manufacture, it is over-injected in an member called core. Thus, a wheel model was developed which, instead of having a gutter for the tire to be simply fitted, it has a “T”-shaped member for the engagement function, wherein the flexible plastic tire and the core are permanently connected and fitted in said member, with no possibility of escape.

Thus, the invention consists of a tire and wheel assembly comprising a part having a substantially rigid material, called a core, wherein the tire will also be permanently attached by over-injection, but it will be attached to the wheel through the core by engagement, so as to ensure that there is no escape, and also by screws. Thus, when the tire is worn, only the tire with the core will simply be detached from the wheel and replaced.

The manufacturing method comprises the following steps: Through a first injection mold the wheel structure is produced and reserved, then in another mold the core is produced, this part (core) is then placed in a third mold that receives the over-injection of the soft plastic that will act as a tire. A tire/core assembly is then produced, wherein only the rigid ends of the core are visible and are then coupled to the wheel. In fact, these parts will then be fitted in the negative of the wheel. It is noticed that to increase the resistance and to prevent the escape from the gutter, such parts can also be screwed to the wheel.

The function of the tire is simply to make contact with the ground, and the core the strong connection between tire and wheel.

During manufacture, when the core enters the third mold, the soft plastic (flexible thermoplastic resin) only fills the “T”-shaped part, joining the two pieces, the indentations of the core, which will be engaged in the wheel, are left out, without receiving this resin.

In a preferred embodiment, the invention comprises a ring-shaped part, with its own structure (core) for locking the resin wherein it is over-injected flexible thermoplastic resin or thermoplastic rubber of hardness between Shore A35 to 90. In this way, it is created a rigid core, inside the flexible tire, with male catches leaving the tire, making it possible to make a connection to the wheel by means of the female recess that is in it. The final attachment can be made by means of snap fit only or the use together with screws. This system, depending on the hardness of the chosen resin, replaces the inflatable tire in terms of shock absorption and, because it is solid, it does not puncture or becomes uncalibrated. As it is not made of a rubber solid, it does not dirty the floor where it passes.

In an alternative embodiment of the invention (not shown in the drawings), the tire assembly comprises a tire injected in PVC (polyvinyl polychloride) of hardness between Shore A 55 to 90, which has a negatives and positives fitting the negatives and positives of the injected wheel. In this way, the wheel and the tire can be easily assembled and disassembled. In order to increase safety, their fastening can be secured by means of plastic pins and screws. The material of the tire has high resistance to wear and it does not dirty the floor. This system replaces the current vulcanized rubber tire.

In fact, the alternative embodiment is an option with lower cost of production, since the rigid core is not used as the tire is directly fitted into the wheel cavities (recesses), which can, in order to increase safety, receive screws that are removed to allow the change when worn.

Both PVC and thermoplastic rubber can be used in the existing embodiments of the present invention, since the decision is associated to the desire of the user.

### BRIEF DESCRIPTION OF THE DRAWINGS

Following, the invention will be described in more detail with the aid of examples shown in the form of Figures.

FIG. 1—shows a perspective view of a core for use in the wheel and tire assembly of the present invention;

FIG. 2—shows a front plan view of the tire core that is used in the wheel and tire assembly of the present invention;

FIG. 3—shows a plan view in detail of a first embodiment of the tire core, which is used in the wheel and tire assembly of the present invention;

FIG. 4—shows a plan view in detail of an alternative embodiment of the tire core, which is used in the wheel and tire assembly of the present invention;

FIG. 5—shows a perspective view of a thrust ring, which is used in the wheel and tire assembly of the present invention;

FIG. 6—shows a front plan view of the detail of a thrust ring, which is used in the wheel and tire assembly of the present invention;

FIG. 7—shows a perspective view of the detail of the thrust ring, which is used in the wheel and tire assembly of the present invention;

FIG. 8—shows a front plan view of the wheel structure used in the wheel and tire assembly of the present invention;

FIG. 9—shows a front plan view of a detail of the wheel structure, which is used in the wheel and tire assembly of the present invention;

FIG. 10—shows a perspective view of a detail of the wheel structure, which is used in the wheel and tire assembly of the present invention;

FIG. 11—is a plan sectional view of the wheel and tire assembly with thrust ring mounted in the present invention; and

FIG. 12—is a perspective view of the wheel and tire assembly mounted with the thrust ring of the present invention.

### DETAILED DESCRIPTION OF THE INVENTION

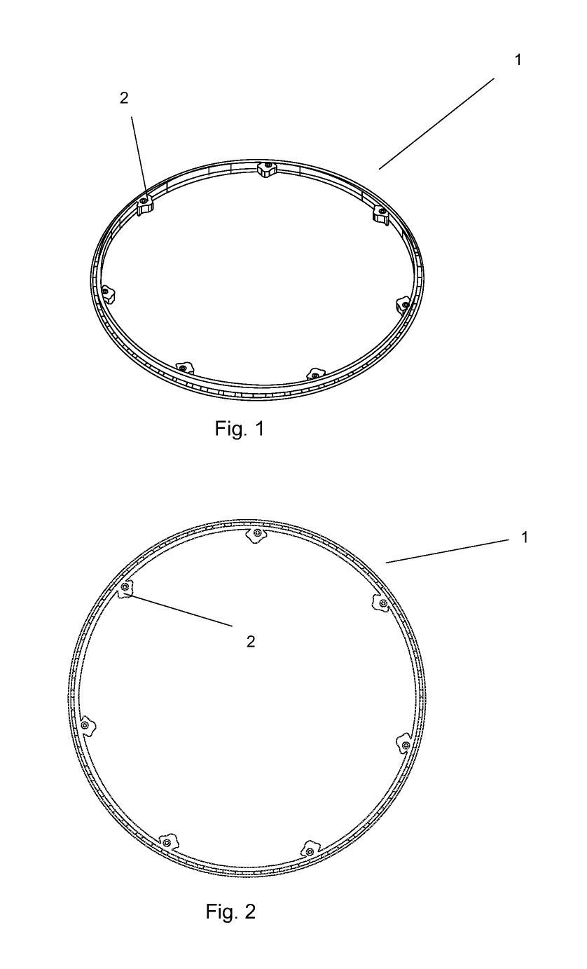

FIGS. 1 and 2 illustrate a circular shaped part, referred to as core 1, having indentations 2 engaging a wheel 12 (see FIG. 8). Said core 1 is made of a rigid thermoplastic resin material, so as to allow the indentations 2 to be reliably and safely engaged to the wheels 12. The amount of indentations 2 ranges due to the greater or lesser need for attachment to the wheel 12. Generally, between 4 to 10 indentations 2 are used for attachment to a wheel 12, but they can vary depending on the need.

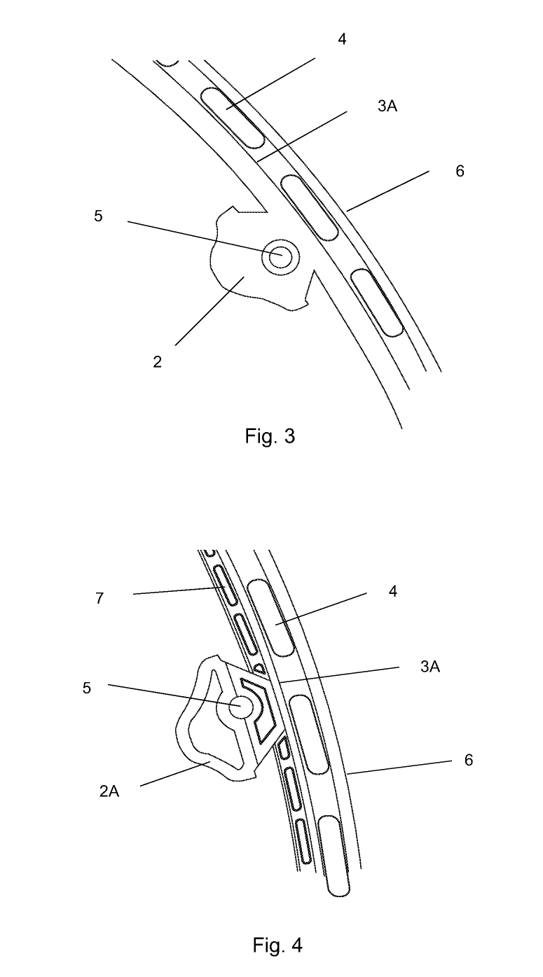

The detail of a first embodiment of the core 1 is illustrated in FIG. 3 and it shows the core 1 containing generally ellipsoid shaped through holes 4 (any other shape may be used) in its body. Such holes 4 are allocated between its upper surface 6 and the lower surface 3A and are arranged along the perimeter of the core 1. The number of holes depends on the size of the wheel to be manufactured and the fixing desired, since they serve to help in the mixing (fixing) of the materials of these two members, said mixing (fixing) occurring by over-injection of the tire material into the core material. Also in FIG. 3, it is shown the indentation 2 that has a hole 5 wherein the reinforcing screw (not shown) is placed to ensure that it will not escape from the gutter of the wheel 12. When the tire material is over-injected, it fits between the ellipsoidal holes 4 and the surfaces of the core 1, so as to provide optimum attachment between the materials and to ensure that they do not separate.

The core 1 provides the assembly with a physical strength which allows for a more efficient running and a proper fastening when its “T”-shaped indentations 2 are engaged in the recesses 15 (see FIG. 8) of the wheels 12.

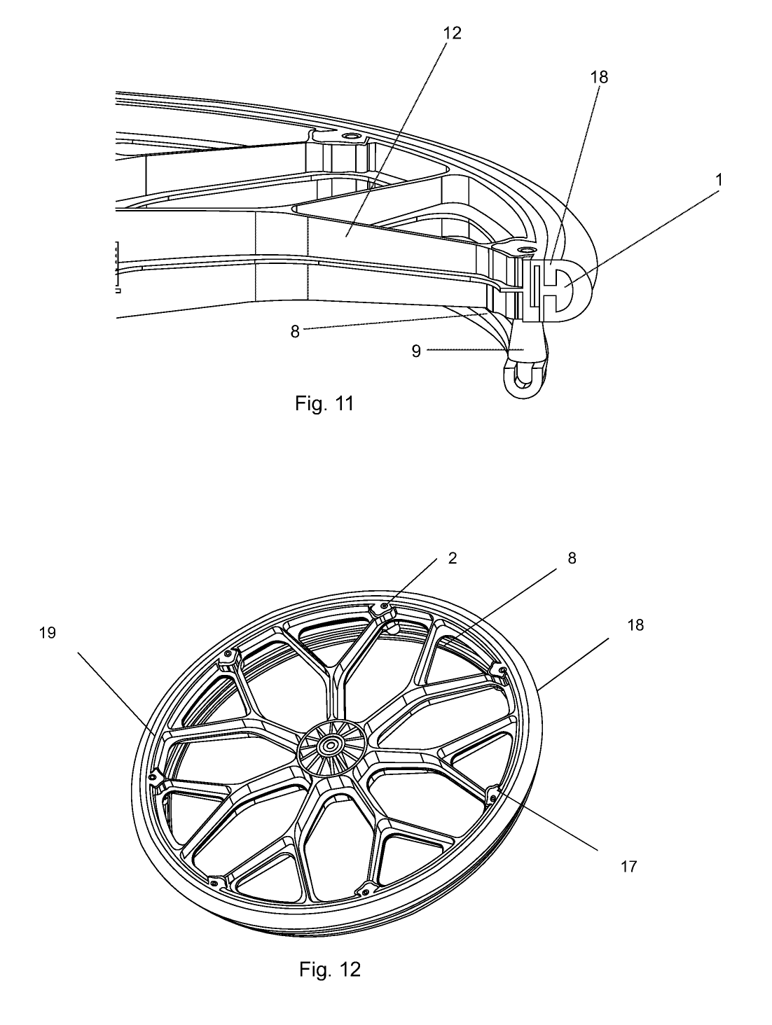

It is noticed that the ellipsoidal holes 4 in addition to assisting in the better attachment of the pneumatic member 18 (see FIG. 11) also help to make the wheel have great softness during its running, since the material of the tire 18 is softer and is disposed between the surfaces 3A and 6.

In FIG. 4, an alternative embodiment of the core 1 can be visualized, wherein the ellipsoidal holes 4 are also disposed on the sides, and smaller ellipsoidal holes 7 are disposed just below the surface 3A. From the surface 3A, indentations 2A are projected to engage in the spaces/recesses 15 (see FIG. 8) of the wheel 12.

The indentation 2A, which is outside the pneumatic member, has through holes 5 so as to allow a screw, to be used in said hole 5, to be inserted therein to give better attachment to the tire 18. The indentation 2 or 2A may have any shape that allows a good fit with a negative (recess 15—FIG. 8) on the wheel, since it is more important the fastening function that such recess 15 exerts so that the tire 18 does not release.

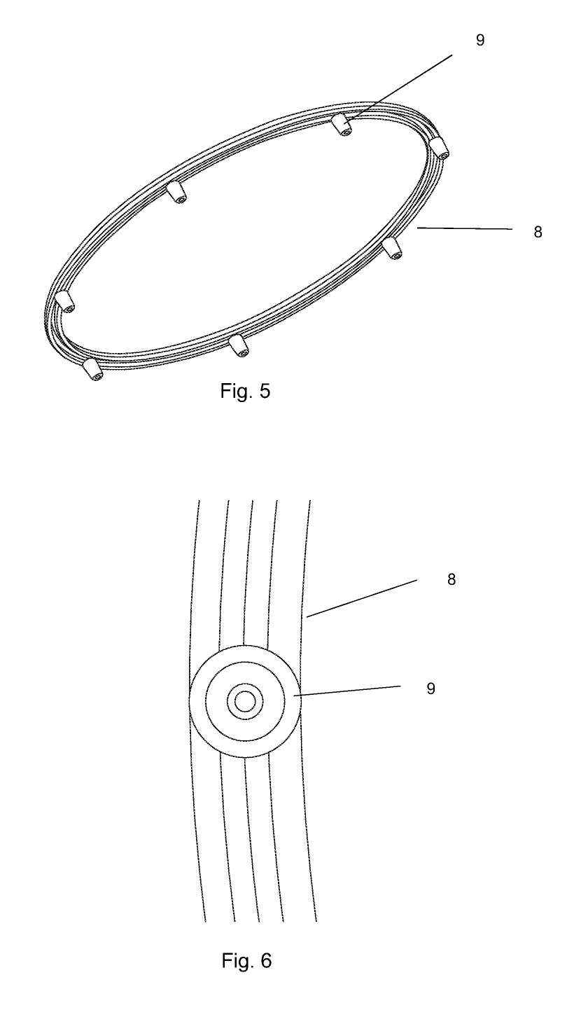

A thrust ring 8 is shown in FIG. 5 and it comprises pins 8 of a preferably conical shape. The number of pins 9 generally ranges between 6 and 9, depending on the fastening quality desired.

In FIG. 6 the pin 9 of the thrust ring 8 can be better visualized. Said pin 9 is fixed to the wheel by means of a screw, said screw being able to be inserted in the hole 5 of the core 1 or at any other point of the wheel, it being sufficient providing support for the use of the thrust ring 8.

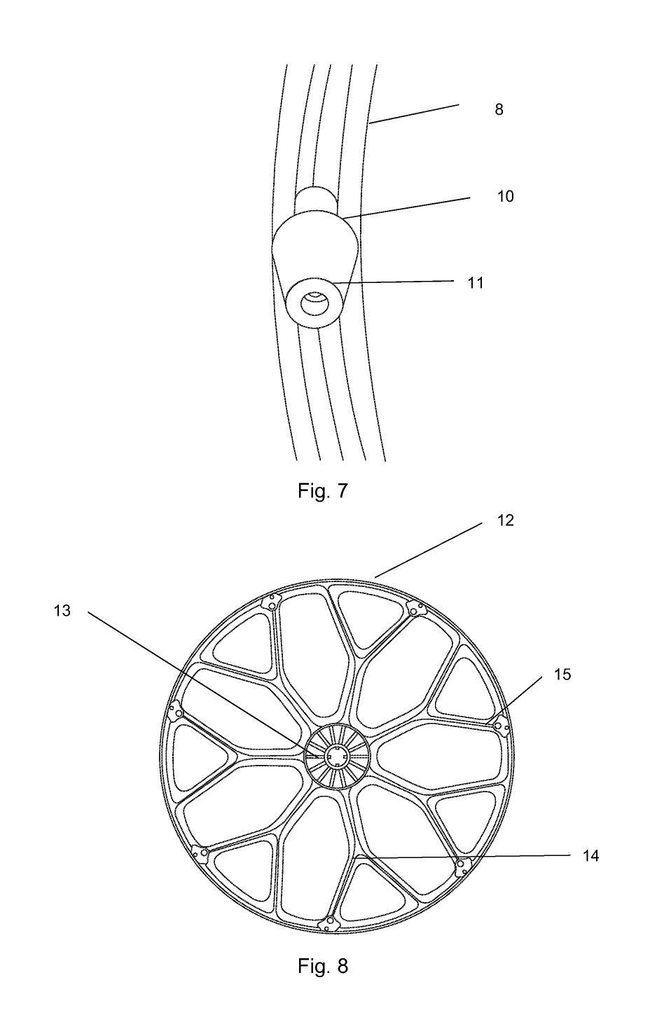

FIG. 7 shows that pin 9 of the thrust ring 8 preferably has a cone shape with circular ends 10 and 11.

The wheel 12 is shown in FIG. 8 and it comprises a hub 13, spokes 14 and recesses 15 in the gutter to accommodate the indentations 2. The spokes 14 may have various configurations, and the present is only to illustrate a possibility. That is, the shape of the spokes 14 is irrelevant to the invention, it being sufficient that they have the function of providing physical resistance to the wheel 12.

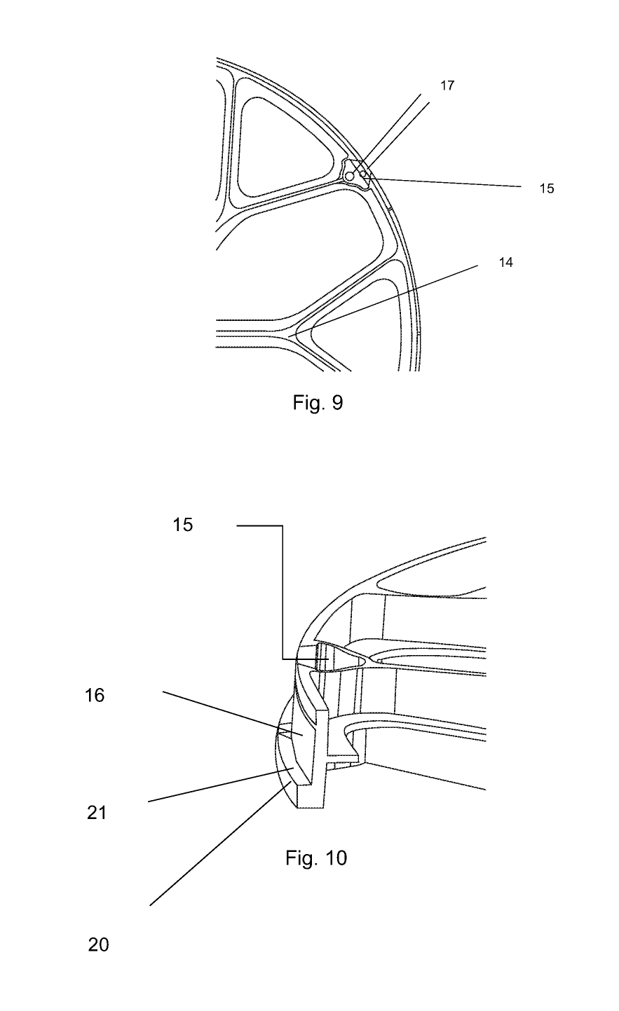

In FIG. 9, it is shown an enlarged detail of a part of the wheel 12 with spokes 14 of the present invention. The recess 15 is illustrated, and there can be seen a through hole 17 serving to secure the core and tire assembly on the wheel 12 by means of a screw. It is noticed, however, that the recess alone will be able to keep the tire attached to the wheel, and that the screw to be inserted in the holes 17 will serve only as a safety item, so as to ensure that the tire will not leave the gutter even in extreme situations. The recess 15 will have the negative shape of the indentation 2 to be used in the core 1.

A further detail of the wheel 12 is illustrated in FIG. 10, where the contact surface 16, which serves for the accommodation of the tire and core assembly, can be seen. This assembly being secured by the recess 15. Preferably, the contact surface 16 is misaligned with the end surface 20 of the wheel, so as to assist in a better fit of the tire and core assembly. Said misalignment provides a wall 21 that serves as a stop for better attachment of the assembly.

FIG. 11 shows the wheel 12, the tire 18 already over-injected in the core 1 and mounted on the thrust ring 8 by means of the pin 9.

A full view of the tire and wheel assembly can be seen in FIG. 12, where a part 19 of the core 1 is apparent. The indentation 2 is duly fitted in the wheel 12 and screws are inserted into the holes 17. The wheel and tire assembly further comprises a thrust ring 8 mounted thereon.

Having been described examples of preferred embodiments, it is to be understood that the scope of the present invention encompasses other possible variations, it being limited only by the content of the appended claims, which includes possible equivalents.

1. A vehicle wheel system, comprising:
a circular shaped member which is internally disposed in a tire material, said member being harder than the tire material and having outer indentations engaging a wheel.

2. The system according to claim 1, wherein the circular shaped member inside the tire is made of a rigid thermoplastic resin material and the indentations lie outside the pneumatic member.

3. The system according to claim 1, wherein the indentations are fitted into recesses of the wheel.

4. The system according to claim 1, wherein the inner circular shaped member has ellipsoid shaped through holes in the perimeter of its body that are filled by the over-injected material of the tire.

5. The system according to claim 4, wherein the holes are allocated between its upper surface and the lower surface.

6. The system according to claim 5, wherein the indentation has a hole wherein a reinforcing screw can be placed.

7. The system according to claim 1, wherein the indentations have a shape that fits snugly in recesses of the wheels.

8. The system according to claim 1, wherein the indentation has a through hole for the screw coupling.

9. The system according to claim 1, comprising a thrust ring with pins for coupling to the wheel.

10. The system according to claim 9, wherein the pins are conical in shape and the number of pins ranges between 6 and 9.

11. The system according to claim 10, wherein the pin of the thrust ring is fixed to the wheel by a fastening member.

12. The system according to claim 11, wherein the pin of the thrust ring has a cone shape with circular ends.

13. The system according to claim 1, wherein the wheel comprises a hub, spokes and recesses in the gutter to accommodate the indentations.

14. The system according to claim 1, wherein the recess has a through hole for fastening the core and tire assembly to the wheel by a screw.

15. A method of manufacturing a wheel and tire assembly comprising the steps of:
producing in a first injection mold a wheel structure and reserving;
producing a member in a plastic resin injection mold, said member to be internally disposed in a tire material;
placing the mold member in a third mold and over-injecting a soft plastic material thereon, said soft plastic acting as a tire.

16. The method according to claim 15, wherein the step of over-injecting the tire in the third mold fills the “T” shaped part of the member and leaves its indentations out of the mold.

17. The method according to claim 16, wherein the step of over-injecting the tire in the third mold fills the through holes of the “T” shaped part of the member.
